(19) United States
(12) Patent Application Publication
(10) Pub. No.: US 2008/0100784 A1
(43) Pub. Date: May 1, 2008

(54) LIQUID CRYSTAL DEVICE AND ELECTRONIC APPARATUS

(75) Inventor: Akihide HARUYAMA, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/851,592

(22) Filed: Sep. 7, 2007

(30) Foreign Application Priority Data
Oct. 30, 2006 (JP) 2006-293635

(51) Int. Cl. G02F 1/1337; G02F 1/1335

(52) U.S. Cl. 349/114; 349/123; 349/128

(57) ABSTRACT

A liquid crystal device is provided which has a first substrate and a second substrate between which a liquid crystal layer is interposed and which performs a display operation by initially changing an alignment state of the liquid crystal layer from a spray alignment to a bend alignment. The liquid crystal device includes: a first initial transfer structure configured to form an initial transfer nucleus of the liquid crystal layer on a side of the first substrate facing the liquid crystal layer; and a second initial transfer structure configured to form the initial transfer nucleus at a position corresponding to the first initial transfer structure on a sire of the second substrate facing the liquid crystal layer with the liquid crystal layer interposed therebetween.

### BACKGROUND

1. Technical Field

The present invention relates to a liquid crystal device and an electronic apparatus, and more specifically to a liquid crystal device of an optically compensated bend (OCB) mode.

2. Related Art

In the field of liquid crystal devices represented by liquid crystal televisions and the like, OCB-mode liquid crystal devices with fast response speed for the purpose of improving image quality of motion images have been much researched in recent years. In the OCB mode, liquid crystal molecules in an initial state are in a spray alignment in which the molecules are dispersed in a spray-like arrangement between two substrates, and liquid crystal molecules are required to be aligned in the shape of a bow during a display operation (bend alignment). High-speed responsiveness is realized by modulating transmittance according to the degree of curvature of the bend alignment during the delay operation. Since liquid crystal is in the spray alignment upon power-off in the case of the OCB-mode liquid crystal device, a so-called initial transfer operation is required to transfer an alignment state of liquid crystal from an initial spray alignment to the bend alignment during the display operation by applying a voltage of more than a threshold volt age upon power-on. In this case, unless the initial transfer is sufficiently performed, poor display may occur and desired high-speed responsiveness may not be achieved. To solve these points, the techniques disclosed in JP-A-2001-30555C, JP-A-2002-296596, and JP-A-2002-207227 have been proposed.

The technique of JP-A-2001-305550 has been proposed to form a protrusion for generation a nucleus for promoting transfer from a spray alignment to a bend alignment to one substrate of a pair of substrates constituting a liquid crystal display panel. The technique of JP-A-2002-296596 has been proposed to provide a structure for promoting transfer of a line conductor (electrode), a protrusion, or the like onto a thin film transistor (TFT) array substrate. The technique of JP-A-2002-207227 has been proposed to perform initial transfer by providing a protrusion in a transmissive portion in a semitransparent reflective type liquid crystal display in which a reflective portion is a reflective-OCB (R-OCB) of a hybrid configuration and the transmissive portion is an OCB configuration.

However, even if a technique disclosed in any of JP-A-2001-305550, JP-A-2002-296596, and JP-A-2002-207227 is adopted, initial transfer may not be sufficiently performed from a spray alignment to a bend alignment at high speed and may not be completed in a short period of time at a low voltage.

### SUMMARY

An advantage of some aspects of the invention is that it provides an OCB-mode liquid crystal device capable of performing initial transfer in a short period of time at a low voltage and an electronic apparatus using the same.

According to an aspect of the invention, there is provided a liquid crystal device having a first substrate and a second substrate between which a liquid crystal layer is interposed and performing a display operation by initially changing an alignment state of the liquid crystal layer from a spray alignment to a bend alignment, the liquid crystal device including: a first initial transfer structure provided on a side of the first substrate facing the liquid crystal layer to form an initial transfer nucleus in the liquid crystal layer; and a second in transfer structure provided at a position corresponding to the first initial transfer structure on a side of the second substrate facing the liquid crystal layer to form the initial transfer nucleus.

In the prior art, an initial transfer structure of a protrusion and like for forming an initial transfer nucleus leading to initial transfer of a liquid crystal layer from a spray alignment to a bend alignment is formed to one substrate. For this reason, only this initial transfer structure may be insufficient to easily generate the initial transfer nucleus. On the other hand, the inventor has found that the bulk of a liquid crystal layer can be efficiently initially transferred by forming initial transfer structures to both sides of two substrates constituting a liquid crystal device and providing the initial transfer structures facing each other through the liquid crystal layer (or arranging the initial transfer structures which planarly overlap with each other). That is, in a liquid crystal device according to an aspect of the invention, a first initial transfer structure and a second initial transfer structure provided at both sides of a first substrate and a second substrate face each other through a liquid crystal layer. Therefore, the first initial transfer structure and the second initial transfer structure cooperatively contribute to formation of an initial transfer nucleus in the liquid crystal layer, thereby performing initial transfer in a short period of time at a low voltage.

It is preferable that at east one of the first initial transfer structure and the second initial transfer structure is a convex portion that protrudes from a surface of the first substrate or from a surface of the second substrate to the liquid crystal layer.

According to this configuration, initial liquid crystal molecules can be obliquely aligned in various directions and can generate oblique electric fields in various directions according to application of an initial transfer voltage. Therefore, disclination can occur in a surface of an uneven oblique portion and an initial transfer operation can be smoothly performed.

It is preferable that at least one of the first initial transfer structure and the second initial transfer structure uses a slit or notch formed in a liquid crystal driving electrode of the first substrate or of the second substrate.

According to this configuration, oblique electric fields can be generated in various directions according to application of an initial transfer voltage. Therefore, disclination can occur in a surface of an uneven oblique portion and an initial transfer operation can be smoothly performed.

It is preferable that at least one of the first initial transfer structure and the second initial transfer structure is an auxiliary electrode for generating an electric field within the liquid crystal layer with a liquid crystal driving electrode of the first substrate and the second substrate.

According to this configuration, an initial transfer operation can be smoothly performed since an oblique electric field is generated in the liquid crystal layer between the auxiliary electrode and the liquid crystal driving electrode of the first substrate or of the second substrate.

It is preferable that the liquid crystal device further includes a plurality of sub pixels arranged in a matrix, wherein the first initial transfer structure and the second initial transfer structure are arranged in a region outside the plurality of sub pixels.

According to this configuration disclination does not badly affect display even when the disclination occurs in the liquid crystal layer by the first and second initial transfer structures since the first and second initial transfer structures are arranged in a region outside the plurality of sub pixels.

It is preferable that the liquid crystal device further includes a plurality of sub pixels arranged in a matrix, one of the plurality of sub pixels having a reflective display region and a transmissive display region, wherein a liquid crystal layer thickness adjusting layer provided in at least the reflective display region reduces a thickness of the liquid crystal layer in the reflective display region to less than a thickness of the liquid crystal layer in the transmissive display region, the liquid crystal layer thickness adjusting layer having an oblique portion between a thin layer thickness region and a thick layer thickness region of the liquid crystal layer, and the first initial transfer structure and the second initial transfer structure are arranged at a position overlapping with the oblique portion of the liquid crystal layer thickness adjusting layer.

Since a region where the oblique portion of the liquid crystal layer thickness adjusting layer does not have the ideal liquid crystal layer thickness (retardation) for any of the reflective display region and the transmissive display region and the alignment of liquid crystal is prone to be corrupted, it results in deteriorating display quality for any of reflective display and transmissive display. Consequently, if the first and second initial transfer structures are arranged at a position planarly overlapping with the above-described region, the bad affection of disclination to display quality can be suppressed at minimum even when the disclination occurs in the liquid crystal layer by the first and second initial transfer structures.

It is preferable that an extension direction of the first initial transfer structure intersects both with a liquid crystal alignment regulating direction of substrate surface in which the first initial transfer structure is formed and with a direction orthogonal to the liquid crystal alignment regulating direction, and an extension direction of the second initial transfer structure intersects both with a liquid crystal alignment regulating direction of substrate surface in which the second initial transfer structure is formed and with a direction orthogonal, to the liquid crystal alignment regulating direction.

According to this configuration, the relationship between a liquid crystal alignment direction upon non-application of voltage at both sides of the extension direction of the initial transfer structure and a direction in which a liquid crystal molecule is rotated is asymmetric. As a result, an initial transfer nucleus is easily formed and an initial transfer operation can be smoothly performed.

It is preferable that an extension direction of the first initial transfer structure and an extension direction of the second initial transfer structure are orthogonal to each other.

According to this configuration, a liquid crystal region where liquid crystal is twist-aligned (twist alignment) can be at least temporarily formed in a region where the first and second initial transfer structures race each other through the liquid crystal layer. In the OCB-mode liquid crystal layer, an energy (or Gibbs energy) state of the twist alignment is positioned between the spray alignment and the bend alignment. Since alignment transfer form the twist alignment to the bend alignment is extremely easily performed, the alignment transfer is more smoothly performed by making the extension directions of the first and second initial transfer structures orthogonal and the initial alignment transfer is quickly completed also in a total of pixels.

According to another aspect of the invention, there is provided an electronic apparatus, including: a liquid crystal device according to the aspect of the invention as described above.

According to this configuration, an initial transfer operation can be smoothly performed and an electronic apparatus with a liquid crystal display unit whose high speed responsiveness is superior can be provided.

### BRIEF DESCRIPTION OF THE DRAWINGS

The invention will be described with reference to the accompanying drawings, wherein like numbers reference like elements.

FIGS. 1A and 1B are diagrams illustrating an overall configuration of a liquid crystal device according to a first embodiment of the invention.

FIG. 2 is a diagram illustrating an equivalent circuit of the liquid crystal device.

FIGS. 3A and 3B are diagrams illustrating a configuration of one sub pixel of the liquid crystal device.

FIGS. 4A and 4B are diagrams illustrating two alignment states of liquid crystal in an OCB-mode liquid crystal device.

FIGS. 5A and 5B are diagrams illustrating a portion of an initial transfer structure of the liquid crystal device.

FIGS. 6A, 6B, and 6C are diagrams illustrating another example of the initial transfer structure.

FIG. 7 is a diagram illustrating a still another example of the initial transfer structure.

FIGS. 8A and 8B are diagrams illustrating a another example of the initial transfer structure.

FIG. 9 is a perspective view illustrating an example of an electronic apparatus according to the invention.

### DESCRIPTION OF EXEMPLARY EMBODIMENTS

Hereinafter, embodiments of the invention will be described with reference to the accompanying drawings. However, the technical field of the invention is not limited to the following embodiments. In the drawings to be referenced in the following description, components are shown such that a reduced scale and the like are appropriately changed for convenience of viewing. In component members of the liquid crystal device in the specification, a liquid crystal layer side is referred to as an inner side and a counter side thereof is referred to as an outer side. A minimum unit of image display is referred to as a “sub pixel” and a set of multiple sub pixels with color filters of colors is referred to as a pixel. In a planar region of sub pixels, a region where display is enabled using light incident from a display side is referred to as a “reflective display region, and a region where display is enabled using light incident from a back side of the liquid crystal device (or the side opposite the display surface) is referred to as a “transmissive display region”.

### First Embodiment

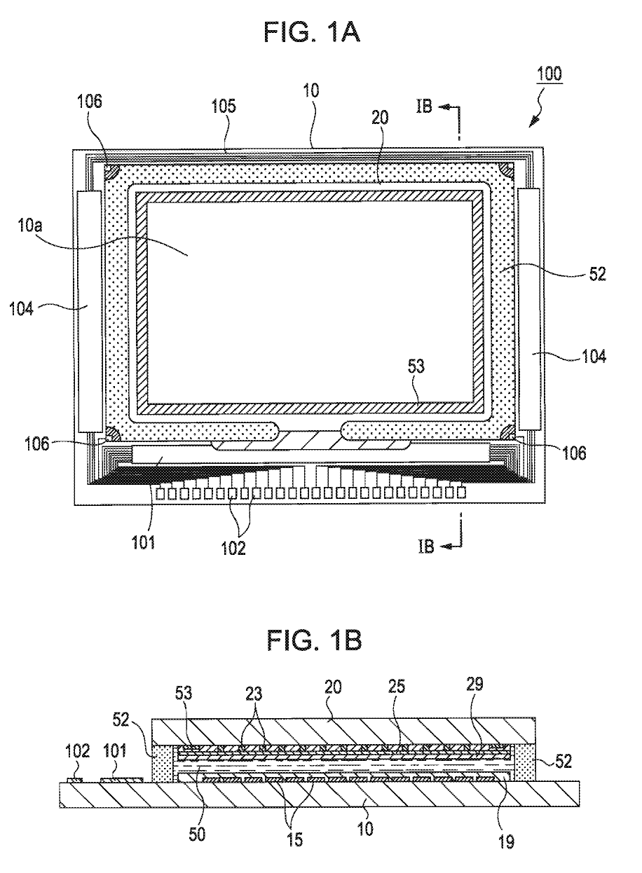

A liquid crystal device according to a first embodiment of the invention will be described with reference to FIGS. 1A to 4B.

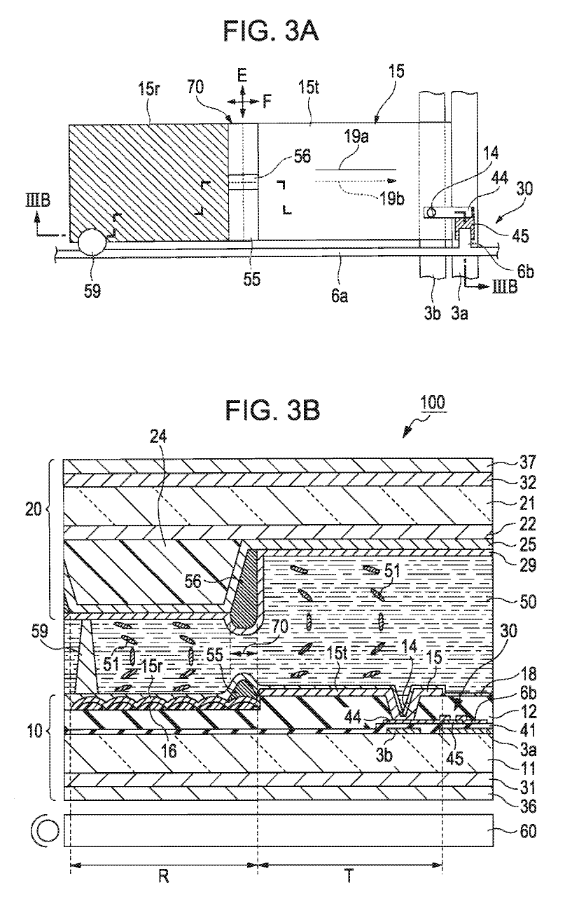

In this embodiment, the liquid crystal device is an active matrix type liquid crystal device adopting a TFT element as a pixel switching element. As shown in FIG. 3, a semitransparent reflective type liquid crystal device of a so-called multigap system includes a TFT array substrate 10 (or a first substrate), a counter substrate 20 (or a second substrate) arranged facing the TFT array substrate 10 and arranged at an observer side, a liquid crystal layer 50 interposed between the substrates 10 and 20, a reflective electrode 15r for reflecting light incident from the side of the counter substrate 20 provided on the TFT array substrate 10, and a liquid crystal layer thickness adjusting layer 24 for reducing a thickness of the liquid crystal layer 50 in a reflective display region R where the reflective electrode 15r is present to less than a thickness of the liquid crystal layer 50 in a transmissive display region T where the reflective electrode 15r is not present.

FIG. 1A is a plan view showing components of a liquid crystal device 100 of this embodiment seen from the side of the counter substrate, and FIG. 1B is a side sectional view taken along the line H-H′ of FIG. 1A.

In the liquid crystal device 100 of this embodiment as shown in FIGS. 1A and 1B, the TFT array substrate 10 and the counter substrate 20 are bonded together by a sealant 52, and the liquid crystal layer 50 is enclosed in a region partitioned off by the sealant 52. A data signal driving circuit 101 and an external circuit mounting terminal 102 are formed in a peripheral circuit region outside the sealant 52 along one side of the TFT array substrate 10, and scanning signal driving circuits 104 are formed in regions along two sides adjacent to the one side. Moreover, electrical connectors 106 for establishing an electrical connection between the TFT array substrate 10 and the counter substrate 20 are disposed in corners of the counter substrate 20.

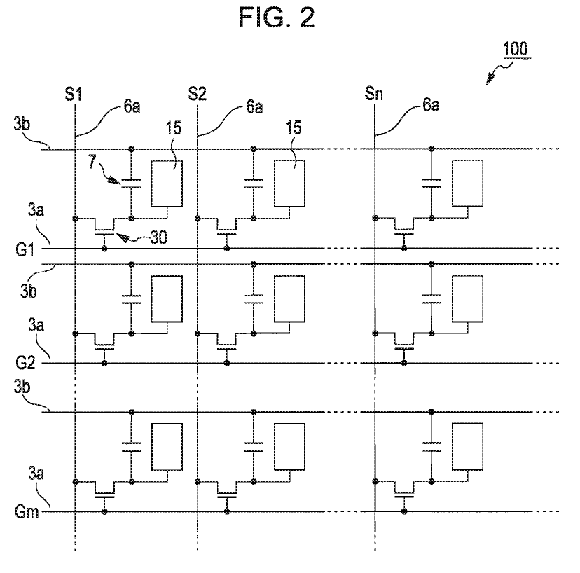

FIG. 2 is an equivalent circuit diagram of the liquid crystal device 100 using the TFT element. In an image display region of the liquid crystal device 100, data lines 6a and scanning lines 3a are arranged in a lattice and sub pixels which are image display units arranged at intersections therebetween. In the multiple sub pixels arranged in a matrix, pixel electrodes 15 are formed. TFT elements 30 serving as switching elements for controlling conduction of the pixel electrodes 15 are formed adjacent to the pixel electrodes 15. Sources of the TFT elements 30 are electrically connected to the data lines 6a. Image signals S1, S2, . . . , and Sn are applied to the data lines 6a.

Gates of the TFT elements 30 are electrically connected to the gate lines (or scanning lines) 3a. Scanning signals G1, G2, . . . , and Gn are applied in pulses at a given timing. The pixel electrodes 15 are electrically connected to drains of the TFT elements 30. When the TFT elements 30 serving as the switching elements are turned on only for a predetermined period by the scanning signals G1, G2, . . . , and Gn supplied from the gate lines 3a, the image signals S1, S2, . . . , and Sn supplied from the data lines 6a are written to the liquid crystal of the respective pixels at a given timing.

The image signals S1, S2, . . . , and Sn written to the liquid crystal are retained by liquid crystal capacitors formed between the pixel electrodes 15 and the below-described common electrode for a predetermined period. In order to prevent the retained image signals S1, S2, . . . , and Sn from leaking, storage capacitors 7 can be provided in parallel to the liquid crystal capacitors between the pixel electrodes 15 and capacitance lines 3b. When a voltage signal, is applied to the liquid crystal as described above, an alignment state of liquid crystal molecules varies with the voltage level applied thereto. Accordingly, light incident to the liquid crystal is modulated and gradation display is possible.

FIGS. 3A and 3B are diagrams illustrating a sub pixel of the liquid crystal device 100 according to this embodiment, where FIG. 3A is a plan-view configuration diagram of one sub pixel and FIG. 3B is a sectional configuration diagram taken along line A-A′ of FIG. 3A.

As shown in FIG. 3A, the above-described data line 6a is arranged along one long side of the rectangular pixel electrode 15 and the above-described scanning line 3a is arranged along one short side of the pixel electrode 15. The scanning line 3b extending in parallel with the scanning line 3a is arranged in the vicinity of the scanning line 3a. In the vicinity of an intersection between the data line 6a and the scanning line 3a, a bottom gate type TFT element 30 is formed. A drain electrode 44 of the TFT element 30 is electrically connected to the pixel electrode 15 through a contact hole 14 at a position to the side of the pixel electrode 15.

As shown in FIG. 3B, the scanning line 3a and the capacitance line 3b are formed at the inner side of a substrate body 11 of the TFT array substrate 10. An insulating thin film 41 is formed over the scanning line 3a and the capacitance line 3b. A semiconductor layer 45 made of an amorphous silicon film of rectangular shape in plan view is formed at a position facing the scanning line 3a through the insulating thin film 41, and a source electrode 6b and the drain electrode 44 partially running onto the semiconductor layer 45 are formed on the insulating thin film 41. An interlayer insulating film 12 is formed over the semiconductor layer 45, the source electrode 6b and the drain electrode 44. The contact hole 14 is formed and reaches the drain electrode 44 by passing through the interlayer insulating film 12. A transparent electrode 15t formed onto the interlayer insulating film 12 (or the pixel electrode 15) is partially buried inside the associated contact hole 14, and the transparent electrode 15t and the TFT element 30 are electrically connected.

On the upper surface of the interlayer insulating film 12, a resin layer 16 whose surface has irregularities is formed at the side far from the TFT element 30 in a longitudinal direction of the sub pixel serving as the image display unit. The reflective electrode (or reflective film) 15r made of a metal material having high reflectivity, such as Al, Ag, or the like, is formed on the surface of the resin layer 16. The transparent electrode 15t made of a transparent conductive material such as indium tin oxide (ITO) is formed at the side close to the TFT element 30 in the longitudinal direction of the sub pixel. The reflective electrode 15r and the transparent electrode 15t are electrically connected to each other to form the pixel electrode 15. A region where the reflective electrode 15r is formed becomes the reflective display region R and a region where the transparent electrode 15t is formed becomes the transmissive display region T.

A color filter layer 22 transmitting light of different colors on a pixel-by-pixel basis is formed at the inner side of a substrate body 21 of the counter substrate 20. It is preferable that color filters are divided into two coloring material regions having different chromaticities in a planar region of the sub pixel. Specifically, a first coloring material region is provided in correspondence with a planar region of the transmissive display region T, a second coloring material region is provided in correspondence with a planar region of the reflective display region R, and the chromaticity of the first coloring material region is larger than that of the second coloring material region. A non-coloring region can be provided in a portion of the reflective display region R. By this configuration, it is possible to prevent the chromaticity of the display light from varying between the transmissive display region T where the display light is transmitted through the color filter only once and the reflective display region R where the display light is transmitted through the color filter two times and to improve display quality by making uniform visual quality in reflective display and transmissive display. The color filter layer 22 can be formed at the side of the TFT array substrate 10.

The liquid crystal layer thickness adjusting layer 24 for reducing the thickness of the liquid crystal layer 50 in the reflective display region R to less than that of the liquid crystal layer 50 in the transmissive display region T is provided at the inner side of the color filter layer 22. The common electrode 25 is formed over substantially the whole surface at the inner side of the liquid crystal layer thickness adjusting layer 24. In the semitransparent reflective type liquid crystal device, light incident to the reflective display region R is transmitted through the liquid crystal layer 50 two times, whereas light incident to the transmissive display region T is transmitted through the liquid crystal layer 50 only once. Accordingly, when the reflective display region R and the transmissive display region T are different from each other in terms of retardation of the liquid crystal layer 50, uniform image display is not achieved due to occurrence of a difference in optical transmittance. Accordingly, by providing the liquid crystal layer thickness adjusting layer 24, the thickness (for example, about 2 μm) of the liquid crystal layer 50 in the reflective display region R is set to about half the thickness (for example, about 4 μm) of the liquid crystal layer 50 in the transmissive display region T. The reflective display region R and the transmissive display region T are substantially equal to each other in terms of retardation of the liquid crystal layer 50. Accordingly, the multigap structure can be realized by the liquid crystal layer thickness adjusting layer 24 and uniform image display can be achieved in the reflective display region R and the transmissive display region T.

An oblique portion 70 of the liquid crystal layer thickness adjusting layer 24 is formed in a boundary region of the reflective display region R and the transmissive display region T. Accordingly, the thickness of the liquid crystal layer 50 from the reflective display region R to the transmissive display region T varies consecutively. An oblique angle of the oblique portion 70 is about 0 degree to 30 degrees with respect to the surface of the substrate body 21. In general, in the oblique portion 70 of the liquid crystal layer thickness adjusting layer 24, an alignment state of liquid molecules is prone to corruption and display quality is prone to degradation. In this embodiment, the liquid crystal display 100 has a configuration focused on transparent display by arranging the oblique portion 70 at the side of the reflective display region R (or the side at which the reflective electrode 5r is present). It is preferable that the liquid crystal layer thickness adjusting layer 24 is made of a material having an electric insulation property and photosensitivity, such as acrylic resin. By employing the photosensitive material, it is possible to pattern the liquid crystal layer thickness adjusting layer with photolithography. The liquid crystal layer thickness adjusting layer 24 can be provided with high precision. The liquid crystal layer thickness adjusting layer 24 can be provided at the side of the TFT array substrate 10.

At the inner sides of both the TFT array substrate 10 and the counter substrate 20 in this embodiment initial transfer structures 55 and 56 (or first and second initial transfer structures) constructed with protruding stripes are formed at a position planarly overlapping with the oblique portion 70 of the liquid crystal layer thickness adjusting layer 24, respectively. The protruding stripes constituting the initial transfer structures 55 and 56 have rough triangular prism shapes, and a rectangular surface of the triangular prism serving as a lower surface is laid on each substrate. As shown in FIG. 3A, when a direction in which a ridge line of the triangular prism extends in each initial transfer structure 55 and 56 (or the longitudinal direction of the triangular prism) is defined as “an extension direction of the initial transfer structure”, the extension direction (as indicated by the arrow E) of the initial transfer structure 55 at the side of the TFT array substrate 10 is orthogonal to the extension direction (as indicated by the arrow F) of the initial transfer structure 56 at the side of the counter substrate 20.

At the side of the TFT array substrate 10, an alignment film 18 made of polyimide or the like is formed over the initial transfer structure 55, the reflective electrode 15r and the transparent electrode 15t. Similarly, at the side of the counter substrate 20, an alignment film 29 made of polyimide or the like is formed over the initial transfer structure 56 and the common electrode 25. A rubbing process is performed on the alignment films 18 and 29 of the substrates 10 and 20. The rubbing process is performed in a direction parallel with the extension direction of the data line 6a (that is, the longitudinal direction of the pixel electrode 15) along the side of the TFT array substrate 10 (as indicated by the arrow 19a) and the side of the counter substrate 20 (as indicated by the arrow 19b) as indicated by the arrows 19a and 19b of FIG. 3A. The rubbing directions 19a and 19b of the substrates 10 and 20 are orthogonal to the extension direction E of the initial transfer structure 55 of the TFT array substrate 10 and are parallel within the extension direction F of the initial transfer structure 56 of the counter substrate 20. In one corner of the sub pixel, a columnar spacer 59 is vertically arranged to regulate the spacing of the TFT array substrate 10 and the counter substrate 20.

As shown in FIG. 3B, the liquid crystal layer 50 operating in the OCB mode is interposed between the TFT array substrate 10 and the counter substrate 20. In this embodiment, horizontal alignment films 18 and 19 are formed in the transmissive display region T and the reflective display region R along the side of the TFT array substrate 10 and the side of the counter substrate 20. The liquid crystal layer 50 of both the transmissive display region T and the reflective display region R operates in the OCB mode.

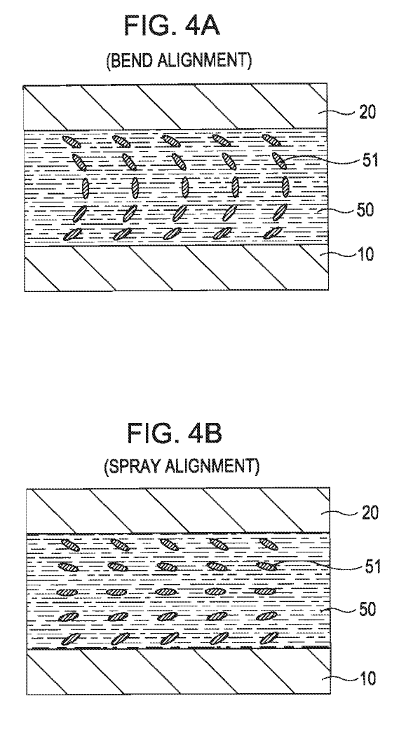

FIGS. 4A and 4B are diagrams illustrating an alignment state of liquid crystal molecules in the OCB-mode liquid crystal device 100. In an initial state as shown in FIG. 4B, liquid crystal molecules 51 are in a spray alignment in which the molecules are dispersed in a spray-like arrangement. During a display operation as shown in FIG. 4A, the liquid crystal molecules 51 are in a bend alignment aligned in the shape of a bow. Transmittance is modulated according to the degree of curvature of the bend alignment during the display operation, such that high-speed responsiveness of the display operation is realized.

Returning to FIG. 3B, polarization plates 36 and 37 are provided at the outer sides of the TFT array substrate 10 and the counter substrate 20. The polarization plates 36 and 37 transmit only linearly polarized light oscillating in a specific direction. The transmission axis of the polarization plate 36 is substantially perpendicular to that of the polarization plate 37. The transmission axis of the polarization plate 36 and the transmission axis of the polarization plate 37 are arranged to intersect with the rubbing directions of the alignment films 18 and 29 at about 45 degrees. At the inner sides of the polarization plate 36 and the polarization plate 37 (or the sides of the substrate bodies 11 and 21), a phase difference plate 31 and a phase difference plate 32 are arranged, respectively. If a λ/4 plate having a phase difference of a substantially ¼ wavelength with respect to the wavelength of visible light is used for the phase difference relates 31 and 32, a circular polarization plate can be configured along with the polarization plate 36 and the polarization plate 37. If a combination of a λ/4 plate and a λ/2 plate is used, a broadband circular polarization plate can be configured.

An optical compensation film (not shown) can be arranged at the inner sides of the polarization plate 36 and the polarization plate 37. When the liquid crystal device 100 is seen in front view or oblique view, a phase difference of the liquid crystal layer 50 can be compensated for and contrast can be increased while reducing optical leakage, by arranging the optical compensation film. The optical compensation film can use a negative uniaxial medium obtained by hybrid-aligning discotic liquid crystal molecules whose refractive index anisotropy is negative (for example, a wide view (WV) film manufactured by Fiji Film Co., Ltd). The optical compensation film can use a positive uniaxial medium obtained by hybrid-aligning discotic liquid crystal molecules whose refractive index anisotropy is positive (for example, an NH film manufactured by Nippon Oil Corp.). A combination of the negative uniaxial medium and the positive uniaxial medium can be also used. Alternatively, a positive C-plate, a biaxial medium in which refractive indices in respective directions are nx>ny>nz, and the like can be used.

A back-light (or illumination unit) 60 having a light source, a reflector, a light guide plate, or the like is installed at the outer side of the counter substrate 20.

Since the liquid crystal layer 50 is in a spray alignment state upon power-off in the case of the OCB-mode liquid crystal device as described above, the alignment state of the liquid crystal molecules 51 is transferred from the initial spray alignment as shown in FIG. 4B to the bend alignment during a display operation as shown in FIG. 4A by applying a voltage of more than a threshold voltage upon power-on, and a so-called initial transfer operation is required. When the initial transfer is not sufficiently made, a display failure occurs and the desired high-speed responsiveness is not achieved. Accordingly, in the initial transfer operation of the liquid crystal layer 50, the scanning lines are line-sequentially turned on and a pulse voltage of about 15 V is applied between the pixel electrode 15 and the common electrode 25. If disclination occurs in the sub pixel by applying the initial transfer voltage, the disclination serves as a transfer nucleus and the initial transfer is circumferentially made. Thus, the initial transfer operation can be smoothly performed.

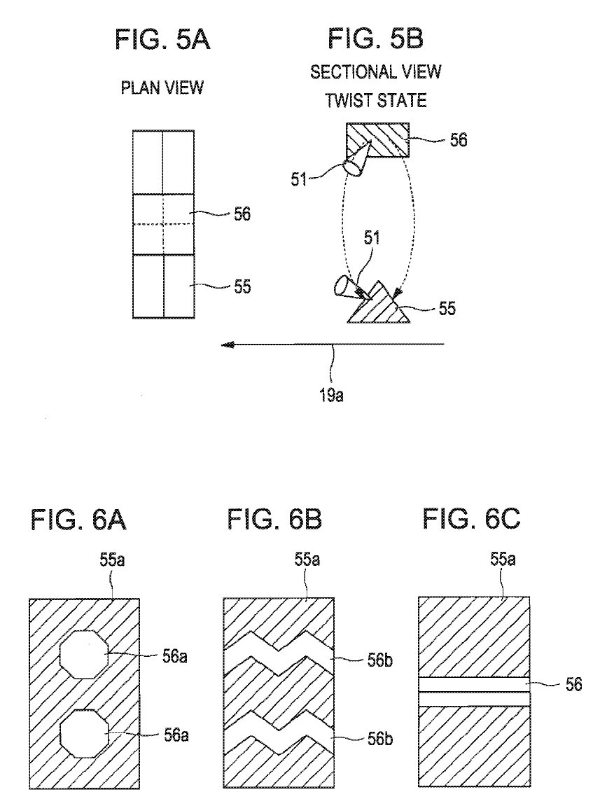

In particular, the initial transfer structures 55 and 56 are provided at a position overlapping with the oblique portion 70 of the liquid crystal layer thickness adjusting layer 24 in the inner surfaces of both the TFT array substrate 10 and the counter substrate 20 as shown in FIG. 3A since the disclination serving as the initial transfer nucleus occurs in the sub pixel in this embodiment. As shown in FIG. 5A, the extension direction of the initial transfer structure 55 at the side of the TFT array substrate 10 is orthogonal to that of the initial transfer structure 56 at the side of the counter substrate 20. Thus, a liquid crystal region where the liquid crystal molecules 51 are twist-aligned (twist alignment) can be at least temporarily formed in a region where the initial transfer structures 55 and 56 face each other through the liquid crystal layer 50 as shown in FIG. 5B. In the OCB-mode liquid crystal layer, an energy state of the twist alignment is positioned between the spray alignment and the bend alignment and the transfer from the twist alignment to the bend alignment is extremely easily performed. For this reason, the alignment transfer is more smoothly performed on the entire bulk of the liquid crystal layer 50 and the initial alignment transfer is quickly completed also on a total of pixels. According to this embodiment, the liquid crystal device available to conduct the initial transfer in a short period of time at a low voltage can be realized.

In this embodiment, the initial transfer structures 55 and 56 are arranged at a position planarly overlapping with the oblique portion 70 of the liquid crystal layer thickness adjusting layer 24 located in a boundary portion of the reflective display region R and the transmissive display region T within the sub pixel. Since a region where the oblique portion 70 of the liquid crystal layer thickness adjusting layer 24 does not have the ideal liquid crystal layer thickness (or retardation) for any of the reflective display region R and the transmissive display region T and results in disclination, display quality is deteriorated in terms of any of reflective display and transmissive display. Consequently, the bad affection of disclination to display quality can be suppressed at minimum even when the disclination, occurs in the liquid crystal layer 50 by positioning the first and second initial transfer structures 55 and 56.

### First Modified Example of First Embodiment

In the embodiment as described above, the initial transfer structures 55 and 56 are provided at a position mapped to the oblique portion 70 of the liquid crystal layer thickness adjusting layer 24. The initial transfer structures 55 and 56 do not need to be limited to this position. Since the initial transfer structures 55 and 56 result in disclination and badly affect at least a display operation, it is preferable that a position in which the initial transfer structures 55 and 56 are formed is selected according to importance of either transmissive display or reflective display. That is, it is preferable that the initial transfer structures 55 and 56 are arranged in the reflective display region R when the transmissive display is important. It is preferable that the initial transfer structures 55 and 56 are arranged in the transmissive display region T when the reflective display is important.

In the embodiment as described above, the initial transfer structures 55 and 56 including the protruding stripes of the triangular prism shapes are formed in the TFT array substrate 10 and the counter substrate 20 such that the extension directions thereof are orthogonal. However, the initial transfer structures 55 and 56 do not need to be necessarily limited to this configuration. For example, as shown in FIG. 6A, a protruding stripe 55a whose upper surface is planar can be formed in any one substrate of the TFT array substrate 10 and the counter substrate 20, and multiple protrusions 56a of island shapes octagonal in plan view (for example, two protrusions) can be formed in the other substrate. Alternatively, as shown in FIG. 6B, a protruding stripe 55a whose upper surface is planar can be formed in any one substrate of the TFT array substrate 10 and the counter substrate 20, and multiple protruding stripes 56b of zigzag shapes in plan view (for example, two protruding stripes) can be formed in one other substrate. Alternatively, as shown in FIG. 6C, a protruding stripe 55a whose upper surface is planar can be formed in any one substrate of the TFT array substrate 10 and the counter substrate 20, and multiple protruding stripes 56 of triangular prism shapes in plan view for example, two protruding stripes) can be formed in the other substrates. A novolac-based positive type photoresist can be adopted as constitution materials of the protrusion and the protruding stripe. After developing of the resist, post bake is performed at about 220° C., such that smooth protrusion shapes can be obtained.

If these types of protrusions are formed, liquid crystal molecules can be obliquely aligned in various directions in the initial state, or oblique electric fields of various directions can be generated in the liquid crystal layer 50 by applying an initial transfer voltage. Accordingly, the liquid crystal molecules whose refractive index anisotropy is positive are rotated from various directions to various directions and are re-aligned in electric field directions. Accordingly, disclination can occur in the surface of the oblique portion. Thus, the initial transfer operation can be smoothly performed.

### Second Modified Example of First Embodiment

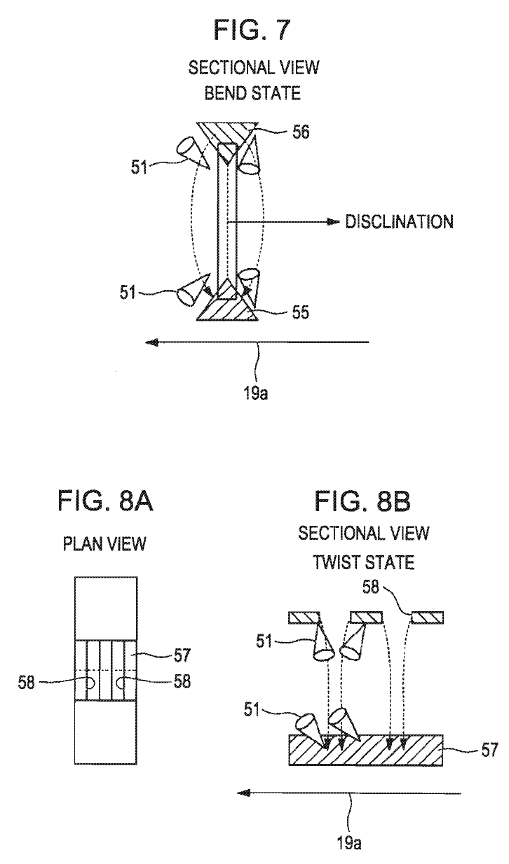

When the initial transfer structures 55 and 56 constructed with the protruding stripes of the triangular prism shapes are formed to both the TFT array substrate 10 and the counter substrate 20, the extension directions thereof can be arranged in parallel as shown in FIG. 7 without making the extension directions orthogonal as in the above-described embodiment. In this case, a process of performing the transfer from the spray alignment to the bend alignment does not go through the twist alignment state, but the liquid crystal molecules are bend-aligned in counter directions at both sides having the centers of ridge lines of the triangular prisms of the initial transfer structures 55 and 56, such that disclination occurs in a region above the ridge lines. The initial transfer can be smoothly performed with a nucleus of this disclination.

### Third Modified Example of First Embodiment

An example in which the protruding stripes are provided as the initial transfer structures 55 and 56 has been shown above. In place of this configuration, a slit or notch can be formed to the pixel electrode 15 on the TFT array substrate 10 or the common electrode 25 on the counter substrate 20. Slits or notches can be formed at the sides of both the TFT array substrate 10 and the common electrode 25. A combination of a slit/notch and a protrusion/protruding stripe can be used such that the slit or notch is formed to one substrate and the protrusion/protruding stripe is formed to the other substrate.

FIG. 8A is a plane configuration diagram showing the case where a piece corresponding to the oblique portion 70 of the liquid crystal layer thickness adjusting layer 24 of FIG. 3A is extracted and a protruding stripe 57 of a triangular prism shape at the side of the TFT array substrate 10 and slits 58 of straight line shapes at the side of the counter substrate 20 are formed. FIG. 8B is a sectional view of the same place. In this example, initial transfer structures 57 and 58 are arranged in a region related to the oblique portion 70 of the liquid crystal layer thickness adjusting layer 24, and the initial transfer structure constructed with the protruding stripe 57 is arranged such that the extension direction of the ridge line of the protruding stripe 57 is in the longitudinal direction of the pixel, electrode 15. On the other hand, the multiple slits 58 formed in the common electrode 25 (for example, two slits) are formed such that the longitudinal direction of the slits 58 is in a direction orthogonal to the extension direction of the ridge line of the protruding stripe 57 (or the lateral direction of the pixel electrode 15).

Thus, the initial transfer structure constructed within the protruding stripe 57 and the initial transfer structure constructed with the slit 58 are orthogonally arranged, such that the direction of the oblique surface of the protruding stripe 57 is orthogonal to the oblique direction of an oblique electric field generated by the slit 58 as shown in FIG. 8B. For this reason, a liquid crystal, region where the liquid crystal molecules 51 are twist-aligned (twist alignment) can be at least temporarily formed in a region where the initial transfer structures 57 and 58 face each other through the liquid crystal layer 50. In the OCB-mode liquid crystal layer as described above, the transfer from the spray alignment to the bend alignment through the twist alignment state is extremely easily performed. In this configuration, a liquid crystal device available to conduct the initial transfer in a short period of time at a low voltage can be realized.

The slit is not limited to the straight line shaper and can be constructed with a bend portion. In addition, a position in which the slit is provided is not limited to a central portion of the electrode, and a portion (or notch) in which the periphery of the electrode is notched can be the initial transfer structure for forming a transfer nucleus.

### Second Embodiment

Hereinafter, a second embodiment of the present invention will be described.

A basic configuration of a liquid crystal device of this embodiment is the same as that of the first embodiment. A difference is that a pair of initial transfer structures are arranged at a position planarly overlapping with a pixel electrode in the first embodiment, but a pair of initial transfer structures are arranged at a position not planarly overlapping with a pixel electrode in this embodiment. Now, this difference will be described.

In the liquid crystal device of this embodiment, the pair of initial transfer structures of a form illustrated in FIGS. 5A and 5B, FIGS. 6A to 6C, FIG. 7, FIGS. 8A and 8B, and the like are arranged at a position not two-dimensionally overlapping with the pixel, electrode 15 or in a region other than a so-called display region. Herein, the display region is a region substantially contributing to display and is a region related to an opening portion of a black matrix dividing coloring material layers of color filters in a region where the pixel electrode 15 is formed. More specifically, the pair of initial transfer structures are arranged at a position planarly overlapping with the data line 6a, the scanning line 3a, the capacitance line 3b, and the like as shown in FIG. 3A.

In this embodiment a liquid crystal device available to conduct the initial transfer in a short period of time at a low voltage can be realized. This embodiment can achieve the same effect as the first embodiment. Since the pair of initial transfer structures are arranged in a region other than the display region, disclination does not badly affect display even when the disclination occurs in the liquid crystal layer by the initial transfer structures.

### Electronic Apparatus

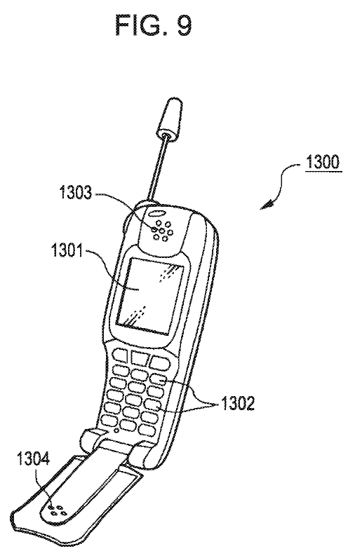

FIG. 9 is a perspective view showing an example of an electronic apparatus according to the invention. As shown in FIG. 9, a portable telephone 1300 is provided with a small-sized display unit 1301 serving as the liquid crystal device of the above embodiment and is constructed with a plurality of manual operation buttons 1302, an earpiece 1303, and a mouthpiece 1304. Since the liquid crystal device can smoothly perform an initial transfer operation of an OCB mode while suppressing the degradation of display quality at minimum, the portable telephone 1300 having a liquid crystal display unit whose display quality is superior can be provided.

The liquid crystal devices according to the embodiments of the invention are not limited to the portable phone and can be suitably used as an image display unit such as an electronic book, a personal computer, a digital still camera, a liquid crystal display television set, a videotape recorder of a viewfinder type or monitor type, a car navigation device, a pager, an electronic notebook, an electronic calculator, a word processor, a workstation, a television phone, a point of sale (POS) terminal, and other devices having touch panels. Even in any electronic apparatus, bright display having high contrast is possible.

The technical range of the invention is not limited to the above-described embodiments and many variations are possible without departing from the spirit of the invention. For example, in the above-described embodiment, the rubbing direction of the surfaces of both substrates is orthogonal to the extension direction of the initial transfer structure of the TFT array substrate and is parallel with the extension direction of the initial transfer structure of the counter substrate. In place of this configuration, a configuration can be provided in which the rubbing direction of the substrate surface (or the liquid crystal alignment regulating direction) and the extension direction of the initial transfer structure intersect at an angle other than 90 degrees. For example, when the above configuration is adopted in the initial transfer structure constructed with a protruding stripe of a triangular prism shape, a rubbing line is obliquely across the ridge line of the triangular prism and the relationship p between a liquid crystal alignment direction upon non-application of a voltage at both sides of the ridge line of the triangular prism and a direction in which liquid crystal molecules are rotated upon application of a voltage is asymmetric. As a result, an initial transfer nucleus is easily formed and an initial transfer operation can be smoothly performed.

In the above-described embodiment, a protrusion/protruding stripe, a slit/notch formed in an electrode, or the like is illustrated as an initial transfer structure. Alternatively, an auxiliary electrode for generating an oblique electric field in a liquid crystal layer with a pixel, electrode or a common electrode can be adopted. In this case, a liquid crystal layer easily makes sufficient initial transfer in a region where auxiliary electrodes of both substrates face each other, such that a liquid crystal device available to conduct the initial transfer in a short period of time at a low voltage can be realized. Since light leakage may occur at a position in which the initial transfer structure is formed, light can be shielded by a light shielding layer or wiring in this position. The invention is applicable to various types of liquid crystal devices irrespective of a semitransparent reflective type/transparent type/reflective type, an active matrix type/passive matrix type, and the like.

What is claimed is:

1. A liquid crystal device having a first substrate and a second substrate between which a liquid crystal layer is interposed and performing a display operation by initially changing an alignment state of the liquid crystal layer from a spray alignment to a bend alignment, the liquid crystal device comprising:
a first initial transfer structure provided on a side of the first, substrate facing the liquid crystal layer to form initial transfer nucleus in the liquid crystal layer; and
a second initial transfer structure provided at a position corresponding to the first initial transfer structure on a side of the second substrate facing the liquid crystal layer to form the initial transfer nucleus.

2. The liquid crystal device according to claim 1, wherein at least one of the first initial transfer structure and the second initial transfer structure is a convex portion protruding from a surface of the first substrate or from a surface of the second substrate toward the liquid crystal layer.

3. The liquid crystal device according to claim 1, wherein at least one of t first initial transfer structure and the second initial transfer structure is a slit or notch formed in a liquid crystal driving electrode of the first substrate or in a liquid crystal driving electrode of the second substrate.

4. The liquid crystal device according to claim 1, wherein at least one of the first initial transfer structure and the second initial, transfer structure is an auxiliary electrode for generating an electric field in the liquid crystal layer between liquid crystal driving electrode of the first substrate or between liquid crystal driving electrode of the second substrate.

5. The liquid crystal device according to claim 1, further comprising a plurality of sub pixels arranged in a matrix,
wherein the first, initial transfer structure and the second initial transfer structure are arranged in a region outside the plurality of sub pixels.

6. The liquid crystal device according to claim 1, further comprising a plurality of sub pixels arranged in a matrix, one of the plurality of the sub pixels having a reflective display region and a transmissive display region,
wherein a liquid crystal layer thickness adjusting layer is provide in at least the reflective display region to reduce a thickness of the liquid crystal layer in the reflective display region to less than a thickness of the liquid crystal layer in the transmissive display regions the liquid crystal layer thickness adjusting layer having an oblique portion between a thin layer thickness region and a thick layer thickness region of the liquid crystal layer, and
the first initial transfer structure and the second initial transfer structure planarly overlap with the oblique portion of the liquid crystal layer thickness adjusting layer.

7. The liquid crystal device according to claim 1, wherein an extension direction of the first initial transfer structure intersects both with a liquid crystal, alignment regulating direction of substrate surface in which the first initial transfer structure is formed and within a direction orthogonal to the liquid crystal, alignment regulating direction, and
an extension direction of the second initial transfer structure intersects both with a liquid crystal alignment regulating direction of substrate surface in which the second initial transfer structure is formed and with a direction orthogonal to the liquid crystal alignment regulating direction.

8. The liquid crystal device according to claim 1, wherein an extension direction of the first initial transfer structure and an extension direction of the second initial transfer structure are orthogonal to each other.

9. An electronic apparatus comprising a liquid crystal device according to claim 1.
